(19) United States
(12) Patent Application Publication
(10) Pub. No.: US 2012/0319477 A1
(43) Pub. Date: Dec. 20, 2012

(54) LIGHTING SYSTEM

(76) Inventor: Michael Scott Brownlee, Alameda, CA (US)

(21) Appl. No.: 13/479,266

(22) Filed: May 23, 2012

Related U.S. Application Data
(63) Continuation-in-part of application No. 13/294,174, filed on Nov. 10, 2011.
(60) Provisional application No. 61/411,923, filed on Nov. 10, 2010.
(60) Provisional application No. 61/411,924, filed on Nov. 10, 2010.

(51) Int. Cl. H02J 9/00

(52) U.S. Cl. 307/23; 307/64; 307/66

(57) ABSTRACT

Lighting system utilizing electricity from energy storage and/or alternative energy source during peak usage times to power a load. In one instance, a series of batteries are configured to provide any desired voltage (e.g. 12V for LED lighting and 108V DC for an electric motor for a fan).

### CROSS REFERENCE RELATED APPLICATIONS

This application is a continuation in part application of U.S. application Ser. No. 13/294,174 filed Nov. 10, 2011 and entitled “Lighting System,” which claims priority to U.S. Provisional Application No. 61/411,923, filed on Nov. 10, 2010, and U.S. Provisional Application No. 61/411,924, filed on Nov. 10, 2010. This application is also related to PCT application number ______, entitled “Lighting System”, inventor Michael S. Brownlee, filed May 23, 2012. The contents of each of these patent applications are incorporated by reference in their entirety as though set forth fully below.

### BACKGROUND

Increased demand for electricity and concern for the environment have prompted a number of innovative solutions to the problem of satisfying additional demand for electricity while reducing pollution from electricity-producing sources. Regulatory agencies have increased cost of electricity during peak demand periods to spur creative designs to reduce demand for electricity and/or better utilize available electricity. The invention in various instances provides more economical use of available electricity and consequent favorable impacts on the environment.

### SUMMARY

Provided are various components, systems, subsystems, and methods as described herein. Energy storage may be incorporated into electrical components, systems, subsystems, and methods to provide for more economical operation at various times. A preferred system has at least one DC load and preferably more than one DC load having different voltage and/or current requirements.

In one instance, a system stores grid electrical power produced in off-peak time periods in electrical energy storage systems, and the system uses the stored energy during times that cost of electricity provided by the grid is higher (such as during peak energy-usage periods during the work-day). One or more alternative energy sources may be used as well to charge the electrical energy storage system, supply electricity within the system, or both.

The system is typically configured to have a power supply from a local grid as well as at least one energy storage system. The system may have at least one source of alternative energy in addition to the energy storage system(s) or instead of the energy storage system.

The system may provide AC or DC power output to a load. Preferably there is at least one DC load and therefore at least one DC power output. The AC power and DC power may be the same as received from the grid or other electrical source, or the AC power and DC power may differ in e.g. voltage and/or current from the electrical source. Preferably the one or more DC loads are selected from solid state lighting, fan motor, air conditioning motor, DC appliances in the home or business (e.g. DC-powered microwave ovens, electric heaters for HVAC systems or space-heaters, electric water heaters, ovens, refrigerators, clothes washers and dryers, vacuum and other powered room cleaners), electronics such as computers and related peripherals, server farms, home electronics such as TVs sound systems, DVRs, movie players, and other equipment.

In many instances, there will be more than one DC load, and the voltage and/or current requirements of the first DC load can differ from the voltage and/or current requirements of the second DC load. The system and its associated controller provide the capability to supply each DC load with the electrical power needed for the respective DC loads.

An energy storage system comprised of electrochemical cells, for instance, provides flexibility in being able to supply electrical power having an appropriate voltage and current. Individual cells or groups of cells can be switched to operate in series or in parallel to meet particular voltage and current requirements.

Because certain DC loads such as light-emitting diode lamps require less electrical power than their predecessor lamps, these types of DC loads in particular can utilize energy storage systems such as batteries that fit within, upon, or near standard electrical enclosures or as part of the load (e.g. as part of the LED lamp). This sort of arrangement allows common rechargeable batteries to power the load during peak energy consumption periods, reducing electrical demand during peak periods and consequently avoiding additional emissions from power-plants that would otherwise be required to supply additional electricity during peak usage periods.

Various circuits and components are associated with such systems. In one instance, a system has a controller configured to select an electrical power source from a plurality of electrical power sources based on which of the electrical power sources is the least expensive at that time. A controller as used in this system may be configured as just described and may optionally have additional components that prevent overcharge, damage from power anomalies, damage from heat, and/or damage from thermal or electrical overload.

An electrical control as provided herein may have a body having dimensions to fit within building industry standard electrical control enclosures as found in common wiring systems in homes and offices. The body may therefore have dimensions to fit within or to wiring junctions within the walls of a building structure. The electrical control may also have an AC to DC converter positioned within boundaries of the body. The body can also have first electrical connectors suitable for wired power to be supplied from at least one standard building AC electrical power source and at least one second set of second electrical connectors selected from
a. electrical connectors suitable for DC output power to be supplied into standard building AC electrical wiring in place of the wiring from the standard building AC electrical power source and connected to one or more DC-powered devices, and
b. electrical connectors suited for DC output power to power and control one or more DC-powered devices.

The electrical control may also include connectors to an energy storage system, and preferably the energy storage system comprises rechargeable batteries that fit within and/or upon the body. The electrical control may optionally be self monitoring and protected from anomalies in the supplied AC electricity and from thermal and electrical overload conditions

The electrical control may also include a signal generator configured to provide information in the DC output power to enable human or machine interaction to accomplish a plurality of outcomes from DC-powered devices.

Various configurations as provided by the invention allow controllers and associated equipment as described herein to be retrofit to common switch-boxes, junction boxes, and other industry-standard enclosures that currently provide AC power to equipment. These switch-boxes and other enclosures can instead now house controllers and optionally associated equipment as provided herein for e.g. LED or fluorescent lighting, the use of more efficient DC motors, controls, etc. The invention in one aspect can therefore integrate AC to DC power adapters and optional digital controls into electrical appliance controls within or substitute for standard housings. These configurations enable easy, low cost retrofit to existing wiring and readily provides the benefits of newer technology to older buildings.

The invention in one instance therefore allows, for example, simply changing the switch in a standard electrical box for one provided herein that has a controller integrated into the switch, or alternatively using a fully integrated electronic control enclosure designed to fit within enclosures complying with building standards and screwing in a new switch, bulb or other device to enable the benefits of DC power and control. The wiring architecture, procedures and processes may remain very close to existing legacy AC systems.

The voltage, power, and signals supplied by a controller or system are configurable by several methods. A rotary, DIP, or slide switch with voltage presets may be provided, especially one that fits within a standard electrical control enclosure such as a light-switch box, junction box, or other enclosure as is found in standard wiring applications.

### BRIEF DESCRIPTION OF THE FIGURES

FIG. 1 depicts a series of energy storage components (e.g. batteries) and switches in electrical communication with a first load.

FIG. 2 depicts a charging circuit.

FIG. 3 depicts a second charging circuit.

FIG. 5 illustrates a controller in communication with energy storage and a load comprised of an LED lamp.

FIG. 6 illustrates a second arrangement of controller in communication with energy storage and load.

FIG. 7 illustrates some standard electrical enclosures.

FIG. 8 is a block diagram depicting a control arrangement.

FIG. 9 is a block diagram of a load controller with energy storage and load in communication with one another.

FIG. 10 is a block diagram of one embodiment of a load system controller of the system of FIG. 8.

FIG. 11 is a block diagram of one embodiment of power storage device of the system of FIG. 8.

FIG. 12 is a circuit diagram of one embodiment of power storage controller of the system of FIG. 8.

FIG. 13 is a perspective view of load device of the system of FIG. 1a embodied as a solid-state light emitting device.

FIG. 14 is a perspective view of a load device of the system of FIG. 8 embodied as a lamp.

FIG. 15 is a block diagram of a system which controls the operation of an electrical load, and provides power storage.

FIG. 16 is a block diagram of a system which controls the operation of an electrical load, and provides power storage.

FIG. 17 is a block diagram of a system which controls the operation of an electrical load, and provides power storage.

FIG. 18 and FIG. 19 are block diagrams of circuits which are included in a light switch assembly of the system of FIG. 17.

### DETAILED DESCRIPTION OF THE PREFERRED EMBODIMENT

A system using a controller as described above may have, as one electrical power source, a connection to a standard electrical grid, such as a municipal power grid, for which the cost of electrical power varies with time. Another source of electrical power that may be used additionally or alternatively to grid power is a connection to an energy storage system (e.g. a series of batteries) that the controller may select as a power source. A third source of electrical power that may be used with either or both of the above-mentioned power sources is a connection to an alternative energy source for electricity (e.g. photovoltaic panels).

Consequently, a system may have a controller configured to select from grid power and at least one alternative energy source. A system may have a controller configured to select from grid power and at least one energy storage system. A system may have a controller configured to select from grid power, at least one energy storage system, and at least one alternative energy source. A system may have a controller configured to select from at least one energy storage system and at least one alternative energy source.

In particular, a controller may be configured to assess when to switch from one source of electricity to another and/or to receive an instruction to switch from one source of electricity to another. When a controller is configured to decide when to switch from one source of electricity to another, the programming will typically account for the cost of electricity purchased from the grid and compare the cost or a value representative or inclusive of this cost to a value representing a cost of a second source of electricity, such as electricity from energy storage and/or electricity from an alternative energy source. A controller may therefore assess that electricity from energy storage is to be used at a certain time of business day when the cost of electricity increases to reflect a higher demand period. The controller may also assess that cost of grid electricity has dropped at a certain time of day and therefore begin recharging the energy storage system using grid-provided electricity. The ability to obtain latest cost information (especially if the controller obtains cost information from the provider directly) allows the controller to optimize use of electricity. Instead of using cost information directly in decisions, the times at which such changes are to occur could be programmed into the controller by an operator, or the grid provider may provide signals to the controller indicating when cost increases or decreases. The controller may also be configured to utilize cost of electricity or a surrogate for an alternative energy source such as photovoltaic panels and use electricity from the panels in conjunction with or instead of either or both of the grid power and power from energy storage. An operator may provide the controller with information on which energy source to use and/or energy cost from any number of pieces of equipment, such as wall switches indicating which energy source is to be used, a touch pad on which the operator can input cost data or instruct the controller to change source of electricity, and handheld or other portable devices that communicate with the controller via wire or wirelessly and instruct the controller.

A controller may be a single chip such as an integrated circuit (e.g. an ASIC), a plurality of chips on a single printed circuit board, or a plurality of printed circuit boards in communication with one another through wires and/or wirelessly. A controller may be separated into various circuits that include at least one selected from a current converter, main controller, and load controller.

The current converter may convert alternating cycle electricity into direct current electricity. Alternatively, the current converter may convert AC electricity into AC electricity having a different voltage, and likewise the current converter may convert DC electricity into DC electricity having a different voltage. A current converter may invert DC electricity to provide AC electricity. Preferably, the current converter converts AC electricity into DC electricity.

A main controller may be configured to perform a number of other functions. The main controller may be configured to add a pulsed signal to an electrical signal that the controller receives. The pulsed signal may provide pulsed DC power that has periodic pulses of desired voltage or voltages. The main controller may therefore modulate the amplitude, on-time, and duty cycle of a DC signal. A controller may provide pulsed DC and/or non-pulsed DC of constant or changing voltage. The main controller may also or instead encode information on an electrical signal by pulsing a portion of the electrical signal. Consequently, the main controller may encode information into the portion of a pulsed signal held at highest voltage, the portion of a pulsed signal held at lowest voltage, the portion of a pulsed signal held at reference voltage between highest and lowest voltage, or any combination of these. The main controller may encode pulses in a portion of the pulsed signal in which voltage is increasing or a portion in which voltage is decreasing, alone or in combination with any of the aforementioned methods of encoding or combinations of methods. A controller may have a pulse width modulator as part of the main controller, or the pulse width modulator may be separate from but controlled by the main controller.

A controller may be connected to a DC load that includes or does not include the energy storage system. A DC load may be one or a plurality of lamps such as LED lamps with sufficient illumination to illuminate a work-place in a business, an area of a home, an area outside a house or business, a street, a sign, or other place that requires an LED lamp that produces brighter illumination than e.g. indicator lamps as might be found in an electronic device such as a phone, computer, audio component or system, or other such appliance. A DC load may be a motor connected to an air conditioning system or fan, for instance.

The electrical controller may monitor and protect itself from anomalies in the supplied AC electricity and from thermal and electrical overload conditions. AC power may have over and under voltage conditions. Environmental and overloading the invention may lead to a safe fail mode protection scenario. The invention may implement thyristors, thermomagnets, fuses, polymeric positive temperature coefficient devices (PPTC), circuit breakers, and other protection technologies to achieve protection from these dangers.

A controller may be configured to switch from one source of electrical power to another based on cost of electricity from the first source and availability of electricity from a second source. For instance, the controller may obtain information on cost of electricity from a power grid at a moment in time and assess whether to use electricity from at least one energy storage system and/or at least one alternative energy source. The controller may obtain information on cost at various times of day and/or week input from an input screen such as a touchscreen. The controller may obtain information on cost of electricity from the provider of grid power periodically or as needed over an Internet connection or via a smart grid. The controller may, for instance, obtain information on cost of power from an energy storage source from computer memory or from calculations based on capital cost and life expectancy of the energy storage source. The controller may receive a signal from the smart-grid or another component indicative of the cost of grid energy or an instruction to switch to a less-expensive source of electrical power rather than obtaining information on the cost.

A controller may be configured to switch a first set of the energy storage components of an energy storage system to provide electrical power to a load while other of the energy storage components of the energy storage system are not under load and either continue to be charged or remain without load. A controller may be configured to switch a first set of the energy storage components to provide electrical power to a first load and switch a second set of the energy storage components to provide electrical power to a second load. This is especially useful when the first and second load have different voltage and/or current requirements.

For instance, one load may require a first voltage such as 12V DC and another load may require a second voltage such as 48V DC. A series of energy storage components may be configured with switches so that a first subset of the energy storage components provides the first voltage and a second subset of the energy storage components provides the second voltage.

The invention may be scaled as required; e.g. a 4 watt DC powered LED lamp may demand 12 Vdc while power may be available at 48 Vdc—in such case the capacity of the batteries may be smallish as compared to a solar power array producing 48 Vdc to power a 12,000 watt air handling (HVAC) system. The batteries' small size allows them to be placed in unconventional locations, such as within or upon standard electrical enclosures associated with the load (e.g. wall switches, lamp switches, and lamp fixtures into which bulbs are inserted, junction boxes, circuit breaker boxes).

Electrical storage systems are varied and the invention example herein will use widely available standard dissimilar material battery technology such as alkaline, lead-acid, nickel-zinc, nickel-cadmium, etc.

Various configurations illustrative of the system are described below to aid in understanding certain aspects of the invention.

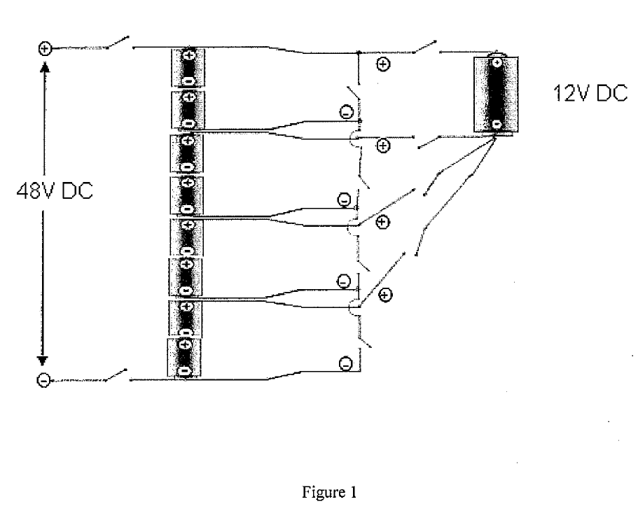

FIG. 1 discloses one possible configuration of energy storage components such as batteries. Each battery depicted in the Figure is a battery of N volts (e.g. a 6V battery), and x batteries are connected in series to provide a voltage of N X×volts. In the example shown, each battery is a 6V battery, and eight batteries are in series to provide 48 VDC. A switch controls a source of electricity having a voltage in excess of 48V DC to charge the batteries. A series of conductors and switches are provided as depicted so that any increment of 12V DC can be utilized for the load (a 12V DC battery depicted on the right in the figure). The switches may be insulated gate bipolar transistors (IGBTs), for instance. On demand from e.g. a load controller which is not shown for clarity the far left switches are closed which presents 48 Vdc across all 8 batteries (and charges them when required).

On demand from said controller the above 48V switch(es) open and the switches to the right of the 48V bank of battery close to present 12V to the battery (and it's load also now shown for clarity). The speed, timing, etc of these switches opening and closing may be at high or low speed as needed.

Further, there are other voltages available in the same manner described above. 6V may be produced via the same practice as long as the 12V and 48V switches are opened when the 6V demand is required.

A system as depicted in FIG. 1 can be configured to provide electricity to multiple loads. For instance, the switches can be set to provide a first voltage to a first set of conductors for a first load (e.g. 12V) and a second voltage to a second set of conductors for a second load (e.g. 24V).

This same concept can be expanded to produce any multiple of N volts (each battery is 6V in the figure) up to N X×volts (e.g. 48V so 6V, 12V, 18V, 24V, 30V, 36V, 42V conversions are possible in the system depicted). For practical purposes one would prefer to balance the loads on the batteries to equalize the discharge rates. Also noteworthy in this example is that the decreased voltage sources would together have a higher amperage capacity.

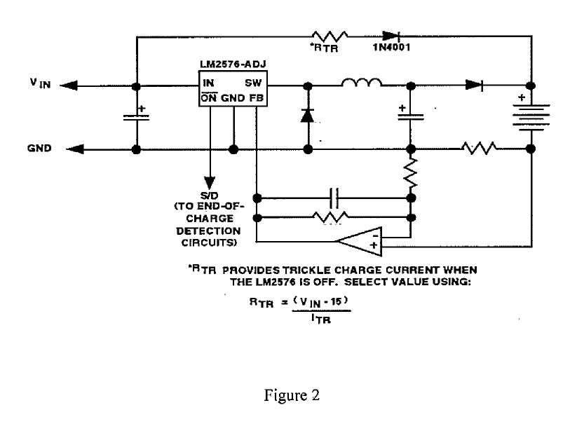

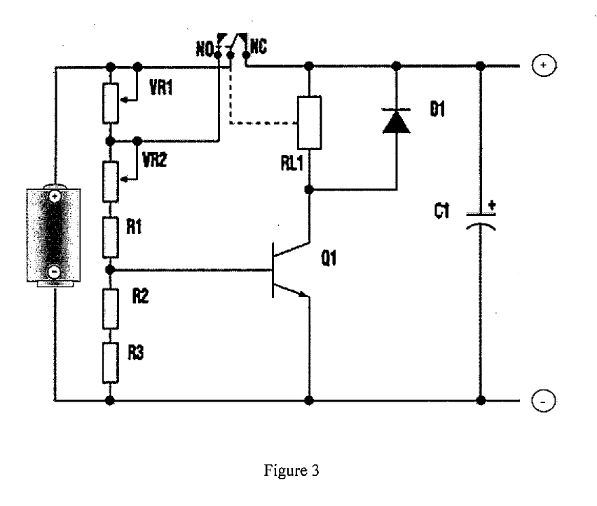

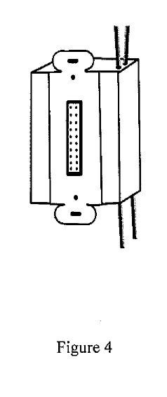

FIG. 2 and FIG. 3 illustrate two charging circuits that may form part of a controller. First, assume that the battery is empty and regulated DC power has not yet been applied to the circuit. At this condition, the relay position will be in normal position. The transistor will be biased through the VR1 path, and the relay will not activate since the battery voltage is not high enough. Then if we connect the DC supply, charge will flow to the battery. The voltage at this condition is still not enough to activate the transistor since the voltage from the transformer is insufficient. The battery voltage will increase over time, and at some point, the voltage Q1 base will be high enough to turn on the transistor and activate the relay. After the relay is activated, the battery is disconnected from the transformer, and the transistor will be maintained on by the battery voltage. You can also see if the biasing path for the transistor base is changed. Before the relay is activated, the path is a voltage divider consists of VR1-VR2-R1-R2-R3, and after the relay is activated, the voltage divider will be only VR2-R1-R2-R3. This means that after the relay is activated to stop the charging process, the transistor is biased by a stronger voltage from the battery, making the voltage point to reactivate charging becomes lower than the point where the charging stops. This hysteresis behavior is useful to prevent an unstable switching of the relay when the battery voltage falls slightly below the point where it stops charging. Without this hysteresis, after the relay is disconnected, although only for small amount, the battery voltage will falls immediately because the charging source is disconnected, and this will cause the relay to oscillate.

Energy storage components such as batteries may be provided in one location, distributed to circuits or points of use, or both. For instance, a set of batteries may be connected in series to provide a higher potential difference across end terminals of the series of batteries. Alternatively or additionally, a small rechargeable battery or set of rechargeable batteries may be positioned on, near, or within a standard electrical control enclosure such as one housing a light switch or a lamp. A lighting fixture may therefore contain a set of batteries that enable the lamp to operate on battery power when a controller switches the lamp to battery power from grid power or from an alternative energy source due to battery power being the least expensive.

As an example, batteries for LED lighting for homes and businesses may be located within light and lamp fixtures and/or wall switches, enabling these light sources to be powered by batteries during the day. Four CR123A lithium batteries (each about ⅔ the size of an “A” cell) or two CR5 lithium batteries (commonly used in cameras) may be used to power 6 W, 8 W, and 10 W LED lamps producing about 400, 600, and 800 lumens respectively. These small batteries can power an individual lamp for a period between 14 and 45 hours, allowing multiple lamps to be powered from a single set of batteries during high-cost periods for energy use purchased from the grid.

The controller may have circuitry such that the first set of energy storage components provide a pulsed DC power signal to the first load. Alternatively or additionally, the controller may have circuitry such that the second set of energy storage components provide a non-pulsed DC power signal to the second load. For instance, a pulsed DC power signal may be used to power lights in which LEDs are configured with opposite polarity in a circuit so that one LED lights as another extinguishes. A second non-pulsed DC power signal may be connected to a DC motor load powering a fan or air conditioner, for instance.

The controller may provide a first pulsed DC power signal to a first load, a second pulsed DC power signal to a second load, and a non-pulsed DC power signal to a third load. This is useful where two lamp circuits are controlled in addition to e.g. a motor for a fan or air conditioner. The controller may switch any of the power sources (grid, energy storage, and/or alternative energy) to provide any of these power signals, so that all of the power signals are from energy storage components, all are from at least one alternative energy source, or all are from grid power. The controller may also utilize two or more of these sources in providing power signals. For instance, DC power from energy storage may be supplied to run a motor, and grid power may be used to power lamps.

Alternative energy sources include geothermal, wind, solar thermal, photovoltaic, tidal, and other sources of energy that are not purchased from an electrical grid. AC or DC power may be provided by these alternative energy sources, and a rectifier may convert AC power to DC power.

A building industry standard electrical control enclosure is an electrical enclosure found within a typical building such as an office building or home. The enclosure may be an enclosure for a switch such as a manually-operated light switch, an electrical outlet, a lamp enclosure, a relay box for operating a motor such as a motor for the building's air-conditioning system, a fan, a fan/light combination as found in many homes and businesses, a junction box, a circuit-breaker panel, or other industry standard electrical control enclosure.

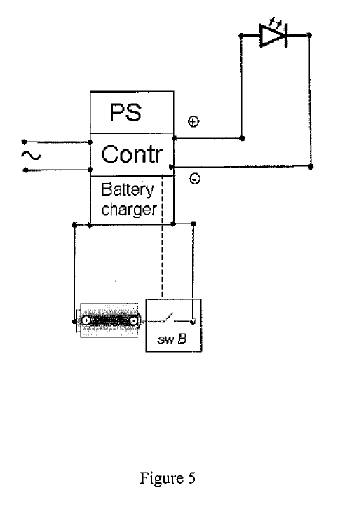

In one instance as depicted in FIG. 5, a controller circuit with battery energizes the lamp. The example lamp uses LED (Light Emitting Diodes) to produce light. This LED lamp includes electrical storage batteries which works in conjunction with another invention listed below

A lamp is supplied energy from a control (switcher, dimmer, etc) which is enabled to respond to power outages and DR demand response signals and/or is programmed to shift electrical load to non-peak energy periods. This system could also use partial battery power and/or combined with dimming the lamps to extend battery power and simultaneously reduce energy usage.

The system is coupled to a battery (electrical energy storage device) wherein the energy sent to the lamp from the control is managed to achieve any combination of lighting level and/or storing energy in a battery (or bank of batteries).

Further, this lamp and control may be arranged such that battery operation of the lamp also powers, or partially powers the control so that (for instance) a dimmer may still function with the lamps while being powered (or partly powered) by the lamp itself.

In the descriptions below the examples are limited for clarity. One skilled in the art would recognize many alternatives to accomplishing the purpose of the described invention. For instance instead of one lamp, many may be powered. Further one skilled in the art would recognize that the switches shown may be substituted for a variety of transistors, IGBTs, Darlingtons, and other switching components for substantially similar functions.

In FIG. 5, “PS” is an AC to DC Power Supply with microcontroller &/or processor

“Contr” is a controller dimming circuit maybe Pulse Width Modulation or current control which includes either a microcontroller &/or processor or otherwise communicative command devices to support the inventions function

“V reg” is a voltage regulator for battery management

“sw B” is a switch which may be discrete or part of another component or not exist depending on Operation:

PS is in communication with mains AC and optionally wireless (or wired) building electrical system.

The PS/Contr can sense the loss of mains AC and deliver appropriate response such as dimming light levels, blinking the lights, and/or displaying the remaining battery life.

PS has the ability to power its microcontroller &/or processor via the external battery so that in the case of building lost power the lamps may be controlled by closing sw B

In the case of a demand response signal from the building electrical utility system &/or a load shifting program with the PS/Contr control device the system decreases the power drawn to minimum levels by using the battery to power the lighting system and/or cycling from mains AC to battery to achieve runtime or power reduction to maximum recommended power.

In the latter case the system may also monitor total power output via the battery, etc to cycle the power draw as necessary for maintaining battery health and/or light levels. Max recommended power may be preprogrammed or interpreted from a DR signal

Alternatively the lamps may be dimmed or other signals recognizable by humans in order for the users to know the system has implemented a power saving scheme.

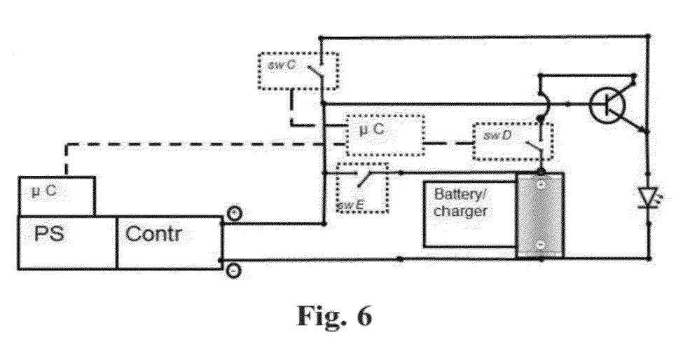

FIG. 6 illustrates a system having a controller configured to select from grid AC and energy storage, such as a battery system. In FIG. 6, “PS” is an AC to DC Power Supply with microcontroller &/or processor

“Contr” is a controller w dimming solution either Pulse Width Modulation or current control

“V reg” is a voltage regulator for battery management “sw C, D, and E” are switches which may be discrete or part of another component “μ C” indicates either a microcontroller &/or processor or otherwise communicative command devices to support the inventions function

### Operation:

PS & μ C combination is in communication with mains AC and optionally wireless (or wired) building electrical utility system as well as the μ C which is in local communication with the sw (switches).

PS has the ability to minimize power draw to levels required to just delivering the PWM signal to the transistor shown by using the battery to power the lighting system.

During normal operation sw C is closed and sw E cycles depending on available power and demand from V reg battery management system.

In the case of a demand response signal from the building electrical utility system &/or a load shifting program with the PS/PWM control device the system decreases the power drawn to minimum levels necessary to drive the transistor so that the battery will supply a determined amount of the power to the lighting system. In this case sw C and sw E would open and sw D would close allowing the battery to supply power to the lamp and control.

In the case of a demand response signal from the building electrical utility system &/or a load shifting program with the PS/Contr control device the system decreases the power drawn to minimum levels by using the battery to power the lighting system and/or cycling from mains AC to battery to achieve runtime or power reduction to maximum recommended power.

The system may also monitor total power output via the battery, etc to cycle the power draw as necessary for maintaining battery health and/or light levels. Alternatively the lamps may be dimmed, time remaining on the batteries or other signals recognizable by humans in order for the users to know the system has implemented a power saving or power loss scheme.

An energy storage system may have multiple batteries, multiple super- and/or ultra-capacitors, multiple flywheel storage units, and/or other multiple energy storage components such as these as part of the energy storage system. The energy storage system may be composed of different types of energy storage components, such as a mixture of batteries and capacitors.

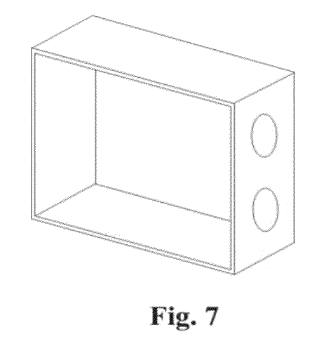

The power storage device typically but not necessarily a battery may be anywhere on the circuit once the DC conversion is made. Batteries may be contained in a standard electrical control enclosure such as one housing a light switch or a lamp, a powered device itself (e.g. part of a replaceable lamp), or separately as a discreet component. FIG. 7 illustrates three examples of a standard electrical control enclosure, a single, dual, and triple switch box, respectively. Standard practice is to route power through these enclosures for electrical switches and outlets. These enclosures come in a variety of sizes and material with typical physical dimensions decided by the planned contents; single, double, triple, quadruple, and ‘gangable’ are common. Gangable boxes are combinations of a series of single, double, etc. switch boxes, and the present invention may be implemented in gangable boxes by connecting the output of multiple electronic controls in parallel or series configuration known in the art. In one instance, a controller or component of the controller and/or energy storage is designed to fit within or replace these and similar standard electrical boxes found within buildings worldwide. Fitting within or replacing these standard boxes permits a more flexible and readily accomplished conversion to DC power within a building.

A touchscreen is a display which can detect the presence and location of a touch within the display area. Touch herein generally refers to contact with the display of the device by a finger(s) or hand. Touchscreens may also sense other objects such as a stylus for locating more accurate and detailed commands.

The touchscreen has multiple technologies available for locating the coordinates on the screen where it is being touched. A coded key or complex command otherwise entered to this embodiment may open a setup display wherein the services, display content, outputs, and other functionality may be selected.

Alternately the services, display content, outputs, and other functionality may be programmed via communication over AC wiring or wirelessly with the invention.

AC power and optional wired command input(s) and DC output(s) connection(s) include one or more standard building AC power for input power and DC power output connections. This embodiment permits other connections for input: wired data connections such as network wiring, analog or digital video and audio inputs. Wireless input connections (not shown) may also supply multipurpose data communication to supplement or as an alternate to wired data connections. The power and space available in this embodiment enable multiple functions and display options driven by onboard programming or as peripheral(s) to other networked controllers or computers. One or more DC power and control outputs may control a plurality of connected devices or appliances.

FIG. 4 presents one embodiment wherein the invention implements a programmable faceplate module. The programmable faceplate module may be programmed via wired or wireless communication and otherwise would have onboard programming. The faceplate may contain the programmed function along with the controller. The faceplate could also present the human and/or machine interface for desired control of DC output and powered device/appliance functionality. Programming and functionality would be passed to the AC to DC converter assembly housed within the enclosure via a standardized connector(s) interfacing the faceplate with the electronics housed within the enclosure. One or more output DC power signals may have embedded communications such as an overlaid pulsed signal sent to controlled devices. In this manner as devices are added or replaced to the powered circuit simply replacing the faceplate would add new functionality. Some examples: a timer/switch faceplates could become dimmer/switch/timer by removing and replacing the faceplate. Communication to and from the controller in the faceplate enables the control and when enabled the controlled devices act as peripherals to other networked controllers or computers.

All versions of this electrical control could have options to include settings via switches or programming via computer connection for voltage, power, and other output settings needed for the multitude of fixtures/devices provided herein.

The electrical control enables human or machine interaction to accomplish desired outcomes from electrically powered devices (on/off, dimmer, scenes, etc.) commands sent either by manual (touch) commands or other remote sensing (RF, motion, gesture, biometric, etc. command recognition are available.

Many AC to DC conversion technologies are available; switching power supplies, transformers, rectifiers, and multiple switched mode and linear power supply technologies are currently available and newer technologies are being steadily developed which present higher power and increased efficiencies. These technologies may be selected to use in this invention.

Remote wired or wireless communication protocols may communicate with the switches or devices. These protocols are well known in the current art and improvements are being steadily developed which permit faster, more reliable, and less expensive communication. Communication to the invention permits remote reconfiguring of not only the output but the input as well. This is especially true for the touch-based embodiments but for example even the switch based embodiment might be reprogrammed to react to multiple on-off cycles to output various lighting scenarios and/or an emergency signal sent to a master controller's security alarm.

Control of powered appliances and devices can be accomplished by human or machines via human touch, pressure sensing, sound recognition, gesture recognition, motion detection, facial recognition, other biometric sensing, wired or radio communication, touchpad, and other interactive methods. (Touchpad being cursor controls as found on many laptop computers). This invention could implement nearly infinite methods of control and resulting actions. Touchscreens combine a display with touch control of a touchpad. Touchscreens could then display control options and execute commands depending on any number of options presented to a user.

Various specific implementations are envisioned. Features for a controller as discussed herein include:

1) An electrical control comprising: a body having dimensions to fit within building industry standards for electrical control enclosures; an AC to DC converter positioned within the body; the body having connections suitable for wired power to be supplied from at least one standard building AC electrical power source(s); the body having connections suitable for DC output power to be supplied into standard building AC electrical wiring and/or other electrical conductors suited for powering and controlling a plurality of DC powered devices; wherein the electrical control is self monitoring and protected from anomalies in the supplied AC electricity and from thermal and electrical overload conditions; wherein the electrical control enables human or machine interaction to accomplish a plurality of outcomes from electrically powered devices; and/or wherein the electrical control interfaces with energy storage and/or an alternative energy source to supplement or supplant grid electricity.

The electrical control and/or the faceplate module may be programmed using programmable component(s). Connection to any of a range of faceplates may generate a plurality of DC electrical output(s) complimentary to the functionality selected when choosing a faceplate. By way of example but not limitation faceplate options would include: 2way On-Off switches, two or more switches, dimmers both rotary or slide versions, timers, motion sensors, cameras, touchpads, touchscreens, piezo switches, and many other control input methodologies. Said faceplate makes electrical contact via configured connector(s) which may be standardized so as to enable one electrical control to have multiple functions and outputs as directed by programmed modules within said faceplate.

The electrical control may be configured by a plurality of digital communication methods to generate a plurality of DC electrical voltages dependant on the commands given via said digital communication methods

The electrical control may be configured to receive AC voltage in the ranges of 90V to 140V, 210V to 264V, or 90V to 264V

The electrical controller may be configured to minimize standby power use from the AC voltage supply, wherein the OFF state of the device presents zero or near-zero power draw to the AC voltage supply.

The electrical controller can therefore be configured to function as dimmers and can be incorporated as multiple switches, 3-way and 4-way switch wiring, and incorporate other components such as motion sensors, timers, cameras, photocells, and biometric devices.

The electrical controller may be an analog to digital converter within or replacing a typical electrical construction box

The electrical controller may contain additional circuits (e.g. protection, noise response, short circuit, etc) for the use of the AC ‘return’ line to be the low (or high) voltage (ground) conductor. These capabilities may be internal or external to the controller or a combination thereof.

The AC ground fault path conductor (bare or green wire in US) can be used for the DC ground.

The electrical controller may also deliver DC power to an electrical outlet for use in powering DC equipment.

The electrical controller may also control and deliver AC output with or without DC output in a system as described.

The electrical controller may produce pulses of current to achieve variable light levels at individual LEDs, so that a pulse of longer duration provides more light from an LED over time.

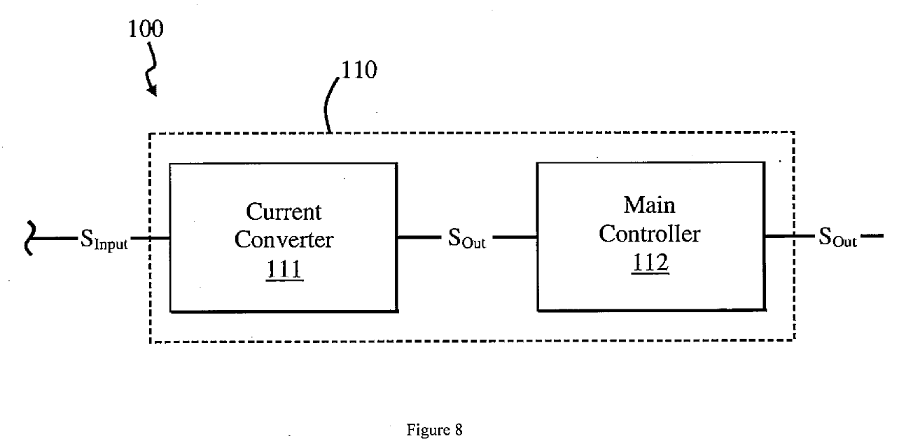

FIG. 8 is a block diagram of a system 100 which controls the operation of an electrical load and power storage. In this embodiment, system 100 includes an electrical load 115 operatively coupled to a control assembly 110. Control assembly 110 can be of many different types. In this embodiment, control assembly 110 includes a current converter 111 in communication with a main controller 112, wherein main controller 112 is in communication with electrical load 115.

In operation, current converter 111 provides an output signal. S_{Out}, when control assembly 110 is activated, in response to receiving an input signal STnpnt. The output signal S_{Out} is provided to main controller 112, and main controller 112 provides an output signal S_{Out} to electrical load 115 when control assembly 110 is activated. Further, control assembly 110 does not provide output signal S_{Out}, when control assembly 110 is deactivated, in response to receiving input signal STnput. It should be noted that control assembly 110 has an activated condition when it is activated, and control assembly 110 has a deactivated condition when it is deactivated.

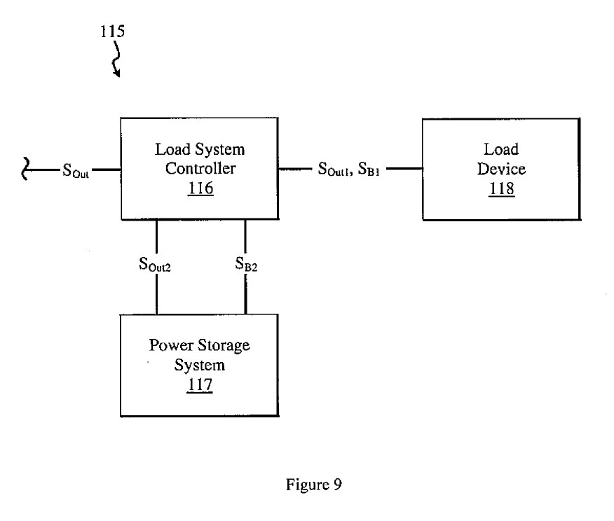

It should also be noted that the output signal which flows between current converter 111 and main controller 112 corresponds to the output signal which flows between main controller 112 and load system controller 116 of FIG. 9. These output signals are both identified as being output signal S_{Out} in FIG. 8 for simplicity and ease of discussion.

Signals S_{B1} and S_{Out} can be of many different types. In one embodiment, signals S_{B1} and S_{Out} are both AC signals. In another embodiment, signals S_{B1} and S_{Out} are both DC signals. In some embodiments, signals S_{B1} and S_{Out} are AC and DC signals, respectively. In some embodiments, signals S_{B1} and S_{Out} are DC and AC signals, respectively.

An AC signal oscillates sinusoidally as a function of time and therefore provides a voltage known at any given time once the parameters defining a single period are known. An AC signal therefore typically has identical high and low voltages in all periods. A DC signal does not oscillate as a function of time in a periodic manner, even when it is a pulsed DC signal. More information regarding AC and DC signals can be found in U.S. patent application Ser. No. 12/553,893. More information regarding AC power, DC power, AC signals and DC signals can be found in U.S. Pat. Nos. 5,019,767, 5,563,782, 6,061,261, 6,266,261, 6,459,175, 7,106,566 and 7,300,302, the contents of all of which are incorporated by reference as though fully set forth herein.

Current converter 111 of control assembly 110 receives input signal Sᵢₙₚᵤₜ and provides output signal S_{Out} to main controller 112 in response. Main controller 112 of control assembly 110 receives output signal S_{Out} from current converter 111 and provides output signal S_{Out} in response. Control assembly 110 provides output signal S_{Out}, when main controller 112 is activated, in response to receiving input signal S_{Input}. Further, control assembly 110 does not provide output signal S_{Out}, when main controller 112 is deactivated, in response to receiving input signal S_{Input}.

Current converter 111 can be selected from many different types of converters, such as an AC-to-DC converter, an AC-to-AC converter, a DC-to-AC converter and a DC-to-DC converter. Examples of converters are disclosed in U.S. Pat. Nos. 5,347,211, 6,643,158, 6,650,560, 6,700,808, 6,775,163, 6,791,853 and 6,903,950, the contents of all of which are incorporated by reference as though fully set forth herein.

In some embodiments, main controller 112 and current converter 111 are positioned proximate to each other. Main controller 112 and current converter 111 can be positioned proximate to each other in many different ways. For example, main controller 112 and current converter 111 can be positioned proximate to each other by coupling them to the same support structure, such as a housing. In this way, main controller 112 and current converter 111 are carried by the same light switch housing. The housing can be of many different types, such as a light switch box and an electrical construction box. In one embodiment in which the housing is a light switch box, main controller 112 is a light switch. Light switch boxes and light switches are also discussed in more detail in the above-referenced U.S. patent application Ser. No. 12/553,893.

In some embodiments, control assembly 110 is housed by the housing. Control assembly 110 is housed by the housing when it extends through an internal volume of the housing. In other embodiments, control assembly 110 is not housed by the housing. Control assembly 110 is not housed by the housing when it does not extend through an internal volume of the housing.

In some embodiments, main controller 112 is housed by the housing. Main controller 112 is housed by the housing when it extends through an internal volume of the housing. In other embodiments, main controller 112 is not housed by the housing. Main controller 112 is not housed by the housing when it does not extend through an internal volume of the housing.

In some embodiments, current converter 111 is housed by the housing current converter 111 is housed by the housing when it extends through an internal volume of the housing. In other embodiments, current converter 111 is not housed by the housing. Current converter 111 is not housed by the housing when it does not extend through an internal volume of the housing.

In some embodiments, a portion of control assembly 110 is housed by the housing and another portion of control assembly 110 is not housed by the housing. For example, in one embodiment, main controller 112 is housed by the housing and current converter 111 is not housed by the housing. In another embodiment, current converter 111 is housed by the housing and main controller 112 is not housed by the housing.

FIG. 9 is a block diagram of one embodiment of electrical load 115. In this embodiment, electrical load 115 includes a load device 118 operatively coupled to a load system controller 116, and a power storage system 117 operatively coupled to load system controller 116. It should be noted that load system controller 116 receives power signal S_{Out} from control assembly 110 (FIG. 8). In particular, load system controller 116 receives power signal S_{Out} from main controller 112. In some embodiments, main controller 112 and load system controller 116 are in communication with each other. Main controller 112 and load system controller 116 can be in communication with each other in many different ways, such as through a wired communication link and a wireless communication link. In some embodiments, main controller 112 controls the operation of load system controller 116.

In one mode of operation, load system controller 116 provides an output signal S_{Out1} to load device 118 in response to receiving output signal S_{Out} Load device 118 operates in response to receiving output signal S_{Out1}. Load device 118 can operate in many different ways, several of which are discussed in more detail below. It should also be noted that the output signal which flows to load system controller 116 corresponds to the output signal which flows between load system controller 116 and load device 118. However, these output signals are both identified as being output signals S_{Out} and S_{Out1}, respectively, in FIG. 9 for ease of discussion.

Load device 118 can be of many different types of devices, such as a light emitting device and/or an appliance. The light emitting device can be of many different types, such as a solid-state light emitting device. One type of solid-state light emitting device is a light emitting diode. Examples of light emitting diode are disclosed in U.S. Pat. Nos. 7,161,311, 7,274,160 and 7,321,203, as well as U.S. Patent Application No. 20070103942. Other types of lighting devices include incandescent and fluorescent lamps. The appliance can be of many different types, such as a computer, television, fan, ceiling fan, refrigerator, and microwave oven, among others. In general, the appliance operates in response to receiving output signal S_{Out1}

In another mode of operation, load system controller 116 provides an output signal SOut2 to power storage system 117 in response to receiving output signal S_{Out} Power storage system 117 operates in response to receiving output signal S_{Out2}. Power storage system 117 can operate in many different ways, several of which are discussed in more detail below. Power storage system 117 can be of many different types of devices, such as a battery. The battery can be of many different types, such as a rechargeable battery. It should also be noted that the output signal which flows to load system controller 116 corresponds to the output signal which flows between load system controller 116 and power storage system 117. These output signals are both identified as being output signals S_{Out} and S_{Out2}, respectively, in FIG. 9 for ease of discussion.

In this embodiment, power storage device 117 operates as a rechargeable battery which provides a power signal S_{B2} to load system controller 116, and load system controller 116 provides a power signal S_{B1} to load device 118. It should be noted that power signals S_{B1} and S_{B2} can be the same or different power signals. It should also be noted that power signals S_{B1} and S_{B2} can be provided to load device 118 when control assembly 110 is deactivated so that output signal Sₒᵤₜ is not provided to load system controller 116. In this way, load device 118 can be provided with power when control assembly 110 is activated and deactivated.

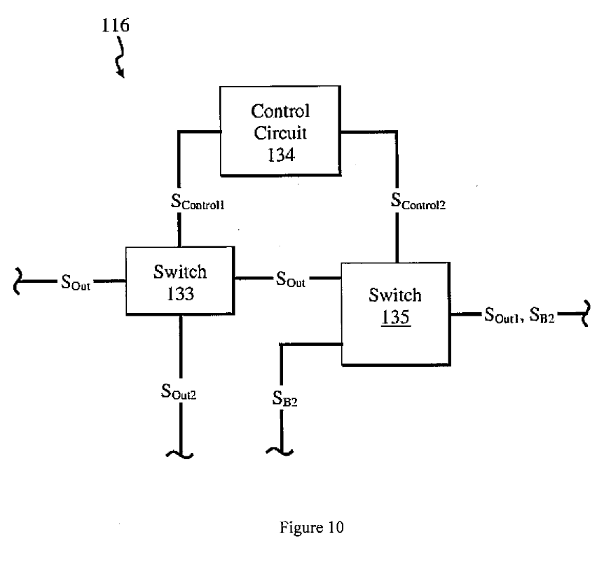

FIG. 10 is a block diagram of one embodiment of load system controller 116. In this embodiment, load system controller 116 includes a switch 133 in communication with a switch 135. In this embodiment, switches 133 and 135 are operatively coupled to a load control circuit 134. In some embodiments, load control circuit 134 is operatively coupled to main controller 112, so that main controller 112 controls the operation of load control circuit 134. In the embodiment depicted in FIG. 10, switch 133 is activated and deactivated in response to receiving a control signal S_{Coutrol1} from load control circuit 134. Further, switch 135 is activated and deactivated in response to receiving a control signal S_{Coutrol2} from load control circuit 134. S_{Coutrol2} may be identical to Sₒᵤₜ or S_{B2} (FIG. 9), or S_{Coutrol2} may be a signal sent by control circuit 134 in response to receiving a signal Sₒᵤₜ or another signal (e.g. a wireless command). Switches 133 and 135 can be of many different types, such as solid state switches and relays. Examples of solid state switches include transistors.

In one mode of operation, switch 133 provides output signal S_{Out} to switch 135 in response to being activated by control signal S_{Control1} from control circuit 134. It should be noted that output signal S_{Out} is provided to load system controller 116 by control assembly 110. In particular, output signal S_{Out} is provided to load system controller 116 by main assembly 112. Switch 135 receives output signal S_{Out} from switch 133 and, in response to being activated by control signal S_{Control2} from control circuit 134, provides output signal S_{Out1} to load device 118 (FIG. 9). As mentioned above, output signals S_{Out} and S_{Out1} can be the same signals or different signals. Load device 118 operates in response to receiving output signal S_{Out1}.

In another mode of operation, switch 133 provides output signal S_{Out2} to power storage system 117 (FIG. 9) in response to being activated by control signal S_{Coutrol1} from control circuit 134. Power storage system 117 receives output signal S_{Out2} from switch 133 and operates in response. Power storage system 117 can operate in many different ways, such as by storing power. As mentioned above, output signals S_{Out} and S_{Out2} can be the same signals or different signals.

In the embodiment in which power storage device 117 operates as a rechargeable battery, power storage device 117 provides power signal S_{B2} to switch 135. Switch 135 receives power signal S_{B2} from power storage device 117 and, in response to being activated by control signal S_{Control2} from control circuit 134, provides power signal S_{B2} to load device 118 (FIG. 9).

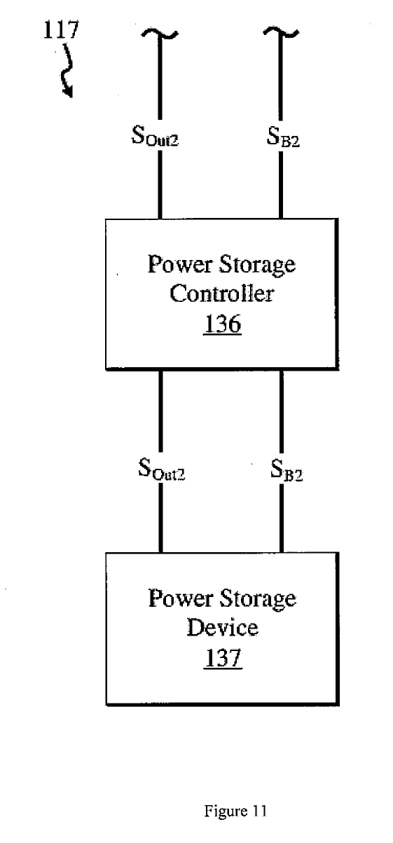

FIG. 11 is a block diagram of one embodiment of power storage device 117. In this embodiment, power storage device 117 includes power storage controller 136 operatively coupled to a power storage device 137. Power storage device 137 can be of many different types, such as a battery and rechargeable battery. It should be noted that power storage controller 136 can be operatively coupled to the other control circuits discussed herein. In some embodiments, power storage controller 136 is operatively coupled to main controller 112 (FIG. 8). In some embodiments, power storage controller 136 is operatively coupled to load system controller 116 (FIG. 9). In some embodiments, power storage controller 136 is operatively coupled to load control circuit 134 (FIG. 10).

In one mode of operation, output signal S_{Out2} is received by power storage controller 136 and, in response to a store power indication, power storage controller 136 provides output signal S_{Out2} to power storage device 137. Power storage device 137 stores power in response to receiving output signal SOut2 in response to power storage controller 136 receiving the store power indication. The store power indication can be provided to power storage device 137 by many different controllers, such as the ones discussed in FIG. 8, FIG. 9, and FIG. 10.

In another mode of operation, power signal S_{B2} is provided to power storage controller 136 and, in response to a provide power indication, power storage controller 136 provides power signal S_{B2}. In the embodiment of FIG. 9, power signal S_{B2} is provided to load system controller 116. In the embodiment of load system controller 116 of FIG. 10, power signal S_{B2} is provided to switch 135. Power indication can be provided to power storage device 137 by many different controllers, such as the ones discussed in FIG. 8, FIG. 9, and FIG. 10.

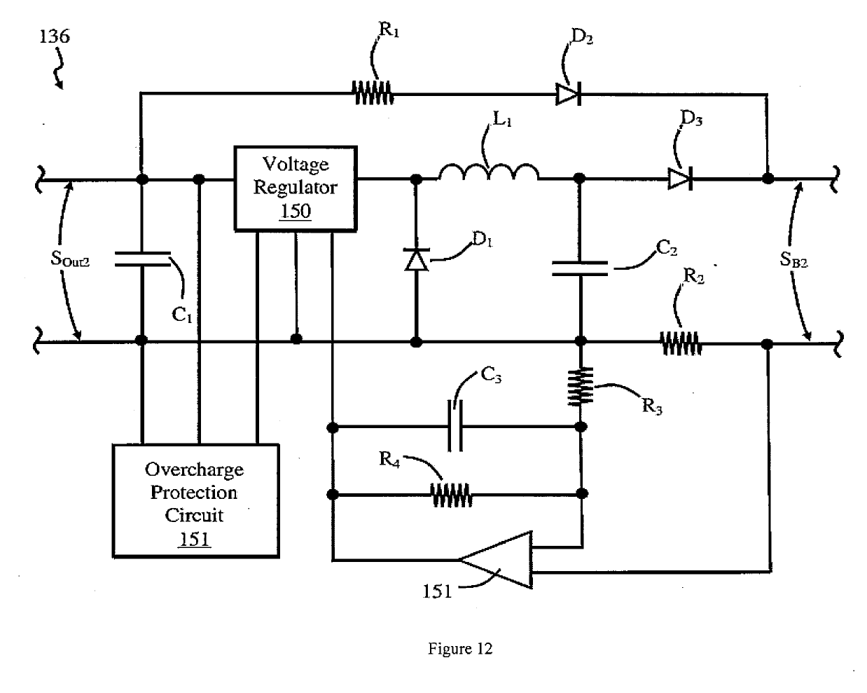

FIG. 12 is a circuit diagram of one embodiment of power storage controller 136. In this embodiment, power storage controller 136 includes a circuit that is sometimes referred to as a High-Efficiency 3 Amp Battery Charger which uses a LM2576 Regulator. More information regarding this circuit can be found in Application Note 946 (AN-946), by Chester Simpson, dated May 1994, and provided by National Semiconductor. The components of the circuit are represented by conventional circuit symbols to denote resistors (R), capacitors (C), inductors (I), diodes (D) and an operation amplifier, which is denoted as element 152. The circuit includes a voltage regulator which is the LM2576 voltage regulator. However, it should be noted that other voltage regulators can be used. In this embodiment, the circuit includes an overcharge protection circuit 151, and more information regarding one embodiment of overcharge protection circuit 151 is provided in AN-946.

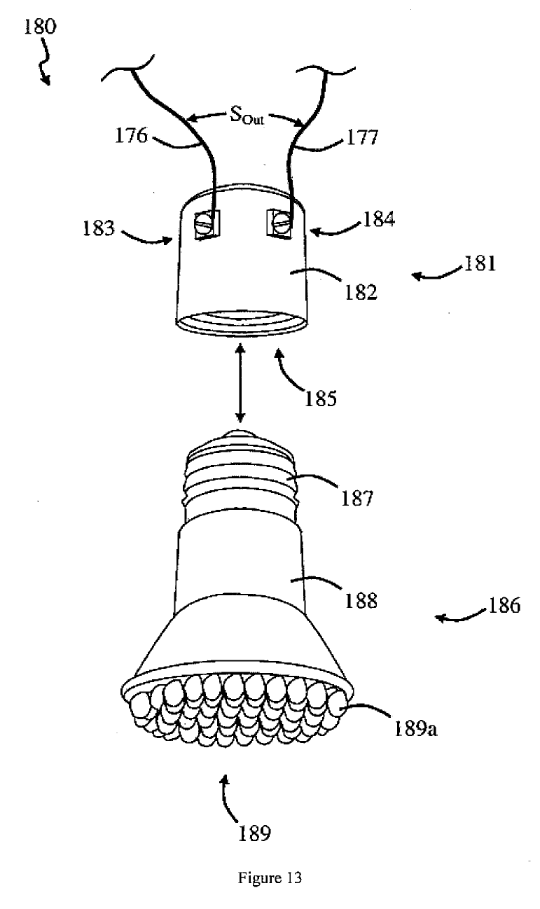

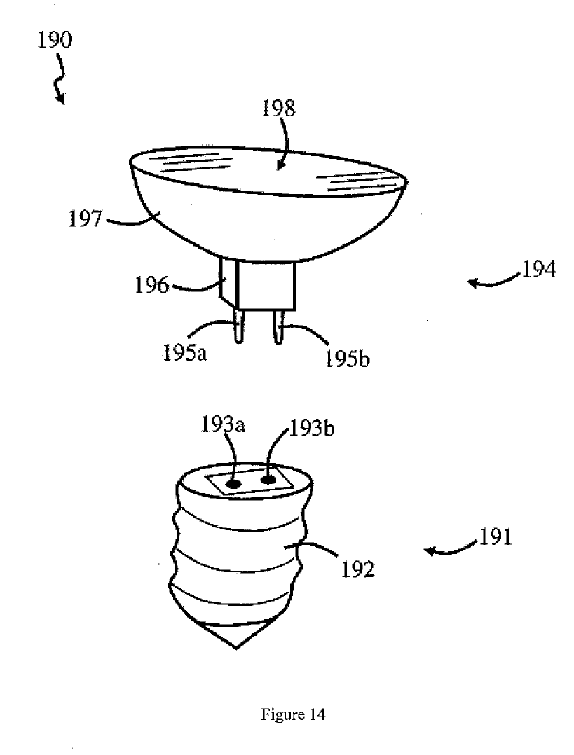

FIG. 13 is a perspective view of load device 118 embodied as a solid-state light emitting device 180. In this embodiment, solid-state light emitting device 180 includes a light socket 181, which includes a light socket body 182. Light socket 181 carries light socket terminals 183 and 184, wherein light socket terminals 183 and 184 are connected to lines 176 and 177. Light socket terminals 183 and 184 are connected to lines 176 and 177 so that output signal S_{Out} is provided to solid-state light emitting device 180. Light socket body 182 includes a receptacle 185 for receiving a lamp, such as a solid-state light emitting device, which will be discussed in more detail presently.

In this embodiment, solid-state light emitting device 180 includes a solid-state lamp 186, which includes a solid-state lamp body 188. Solid-state lamp 186 includes a light socket connector 187 sized and shaped to be received by receptacle 185. Solid-state lamp 186 includes a LED array 189 which includes a plurality of LED's 189a. It should be noted that, in general, solid-state lamp 186 includes one or more LED's. LED array 189 may emit many different colors of light, such as warm white and cool white light.

In one mode of operation, load system controller 116 provides an output signal S_{Out1} to solid-state light emitting device 180 in response to receiving output signal S_{Out}. Solid-state light emitting device 180 operates in response to receiving output signal S_{Out}. Solid-state light emitting device 180 can operate in many different ways, such as by emitting light at a particular brightness and/or color or by turning off.

In another mode of operation, power storage device 117 operates as a rechargeable battery which provides a power signal S_{B2} to load system controller 116, and load system controller 116 provides a power signal S_{B1} to solid-state light emitting device 180. It should be noted that power signals S_{B1} and S_{B2} can be the same or different power signals. It should also be noted that power signals S_{B1} and S_{B2} can be provided to solid-state light emitting device 180 when control assembly 110 is deactivated so that output signal S_{Out} is not provided to load system controller 116. In this way, solid-state light emitting device 180 can be provided with power when control assembly 110 is activated and deactivated.

Light socket body 182, light socket connector 187, and/or lamp body 188 may contain rechargeable batteries. Load control circuit 134 may, for instance, instruct switch 135 to draw power signal S_{B2} from any of these batteries during high-cost periods for electricity purchased from the grid in order to power solid-state lamp 186 using electricity stored during non-peak periods. Once either the battery has discharged sufficiently or power represented by Sₒᵤₜ is less expensive than battery power (because this power is an alternative energy source), load control circuit 134 instructs switches 133 and 135 to direct signal Sₒᵤₜ to solid-state lamp 186.

It should be noted that electrical load 115 is shown as a separate component from control assembly 110 in FIG. 8. However, in some embodiments, control assembly 110 can be included with electrical load 115, as will be discussed in more detail presently.

FIG. 2b is a perspective view of a load device embodied as a lamp 190. Lamp 190 can be of many different types, such as a multifaceted reflector (MR) lamp. There are many different types of multifaceted reflector lamps, such as an MR 16 lamp. Multifaceted reflector lamps are made by many different manufacturers, such as Westinghouse, General Electric and Sylvania, amount others.

In this embodiment, lamp 190 includes a cap assembly 191, which includes a cap 192 which carries connectors 193a and 193b. In this embodiment, cap assembly 191 includes control assembly 110 (FIG. 8) in communication with connectors 193a and 193b. In particular, cap assembly 191 includes current converter 111 and main controller 112, wherein main controller 112 is in communication with connectors 193a and 193b. It should be noted that, in this embodiment, output signal Sout flows between connectors 193a and 193b. In some embodiments, cap assembly 191 includes load system controller 116 and power storage system 117 of FIG. 9. In some embodiments, load system controller 116 of cap assembly 191 is embodied as shown in FIG. 12. In some embodiments, power storage system 117 of cap assembly 191 is embodied as shown in FIG. 11. In some embodiments, power storage system 117 of cap assembly 191 includes the circuit of FIG. 12.

In this embodiment, lamp 190 includes a lamp assembly 194, which is repeatably moveable between connected and unconnected conditions with cap assembly 191. Lamp assembly 194 includes a lamp base 196 which carries a lens housing 197. Lens housing 197 carries a lens 198. Lamp assembly 194 includes a lamp (not shown) which is in communication with complementary connectors 195a and 195b, wherein complementary connectors 195a and 195b extend through lamp base 196. In the connected condition, connectors 193a and 193b and complementary connectors 195a and 195b, respectively, are connected together so that power signal SOut can flow therethrough. In the unconnected condition, connectors 193a and 193b and complementary connectors 195a and 195b, respectively, are unconnected from each other so that power signal SOut cannot flow therethrough. The lamp of lamp assembly 194 provides light in response to power signal SOut flowing between complementary connectors 195a and 195b.

In one mode of operation, load system controller 116 of cap assembly 191 provides output signal SOut1 to the lamp of lamp assembly 194 in response to receiving output signal SOut. The lamp of lamp assembly 194 operates in response to receiving output signal SOut1. The lamp of lamp assembly 194 can operate in many different ways, such as by emitting light.

In another mode of operation, power storage device 117 of cap assembly 191 operates as a rechargeable battery which provides power signal SB2 to load system controller 116, and load system controller 116 provides power signal SB1 to the lamp of lamp assembly 194. It should be noted that power signals SB I and SB2 can be the same or different power signals. It should also be noted that power signals SB1 and SB2 can be provided to the lamp of lamp assembly 194 when control assembly 110 is deactivated so that output signal SOut is not provided to load system controller 116. In this way, the lamp of lamp assembly 194 can be provided with power when control assembly 110 is activated and deactivated.

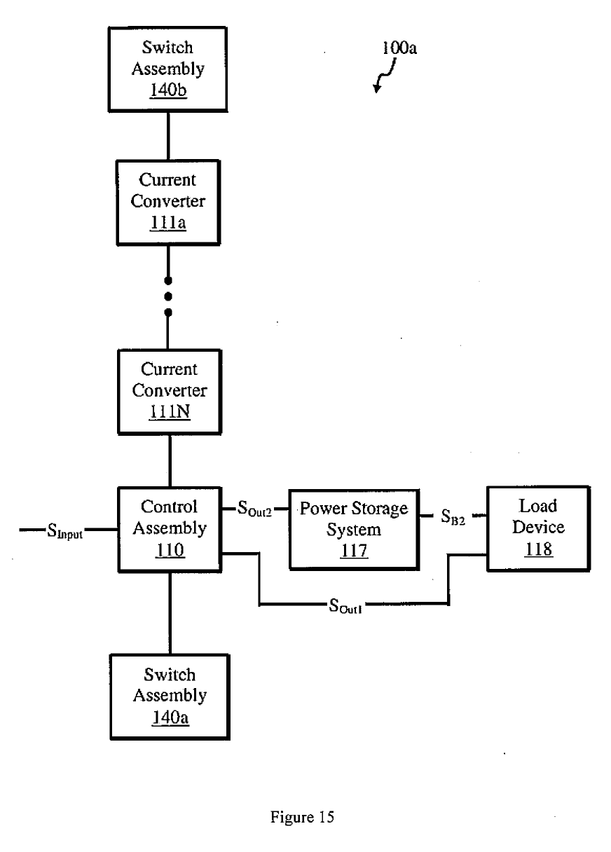

FIG. 15 is a block diagram of a system 100a which controls the operation of an electrical load, and provides power storage. In this embodiment, system 100a includes power storage system 117 operatively coupled to control assembly 110, and load device 118 operatively coupled to power storage system 117. More information regarding control assembly 110, power storage system 117 and load device 118 is provided above.

In this embodiment, system 100a includes switch assembly 140a in communication with control assembly 110. Control assembly 110 is repeatably moveable between the activated and deactivated conditions in response to activating and deactivating switch assembly 140a. When control assembly 110 is in the activated condition in response to activating switch assembly 140a, output signal S_{Out1} flows between control assembly 110 and load device 118. In this way, load device 118 operates in response to receiving output signal S_{Out1}.

Current converters may be any energy storage components and associated equipment such as switches, rectifiers, and other components as needed to provide current compatible with the particular use. Current converters may include batteries connected in series and/or in parallel, capacitors, flywheel energy storage devices, or other energy storage components for an energy storage system.

In this embodiment, system 100a includes switch assembly 140b in communication with control assembly 110 through a number N of current converters 111a, 111b, . . . 111N, wherein N is a whole number greater than or equal to one. The number N is chosen to provide a desired amount of current to control assembly 110. The amount of current provided to control assembly 110 increases and decreases in response to increasing N and decreasing N, respectively. The current flow through the current converters 111a, 111b, . . . 111N is controlled by activating and deactivating switch assembly 140b. The current flows through current converters 111a, 111b, . . . 111N when switch assembly 140b is activated, and the current is restricted from flowing through current converters 111a, 111b, . . . 111N when switch assembly 140b is deactivated.

When control assembly 110 is in the activated condition in response to activating switch assembly 140a, output signal S_{Out2} flows between power storage system 117 and control assembly 110, and power storage system 117 stores power in response. If desired, power storage system 117 provides power signal S_{B2} to load device 118. In this way, load device operates in response to receiving power signal S_{B2}. It should be noted that, in some situations, load device 118 operates in response to receiving signal S_{Out1}, and at other times load device 118 operates in response to receiving signal S_{B2}.

It should be noted that switch assemblies 140a and 140b can be of many different types, such as a light switch assembly and dimmer switch assembly. More information regarding switch assemblies is provided in U.S. patent application Ser. No. 12/553,893.

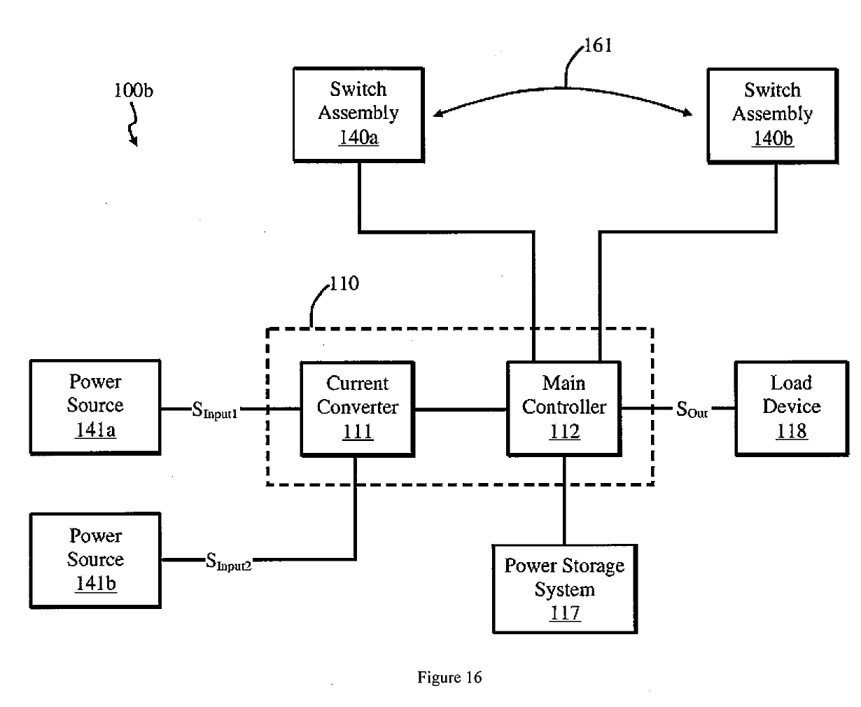

FIG. 16 is a block diagram of a system 100b which controls the operation of an electrical load, and provides power storage. In this embodiment, system 100b includes power storage system 117 operatively coupled to control assembly 110, and load device 118 operatively coupled to power storage system 117. More information regarding control assembly 110, power storage system 117 and load device 118 is provided above.

In this embodiment, system 100b includes a power source 141a which provides a power input signal SInput1 to control assembly 110. Further, system 100b includes a power source 141b which provides a power input signal SInput2 to control assembly 110. Power sources 141a and 141b can be of many different types. In one embodiment, power system 141a is a power grid and power source 141b is an alternative power source. Power source 141b can be of many different types of alternative power sources. Examples of alternative power sources include a solar power source, wind turbine power source, water power source, and a biomass power source, among others. In operation, control assembly 110 provides power signal SOut to load device 118, wherein power signal SOut corresponds to power input signal SInput1 and/or SInput2. In this embodiment, the flow of power input signals SInput1 and/or SInput2 and power signal SOut is adjustable in response to adjusting switch assemblies 140a and/or 140b. Since main controller 112 is in communication with current converter 111, main controller 112 sends an instruction to current converter 111 to provide the desired power source, either in response to at least one of adjustable switch assemblies 140a and 140b or in response to the main controller assessing that a change is warranted. An instruction can be in the form of a pulsed signal sent by main controller across an interconnect between current converter 111 and main controller 112 or sent wirelessly, for instance.

In some embodiments, switch assemblies 140a and 140b are in communication with each other. Switch assemblies 140a and 140b can be in communication with each other in many different ways, such as through a wired link and/or a wireless link. In some embodiments, switch assembly 140a controls the operation of switch assembly 140b. A wireless communication link can be established in many different ways, such as by including a wireless module with switch assemblies 140a and 140b. The wireless module can be of many different types such as those made by Microchip and Atmel Corporation.

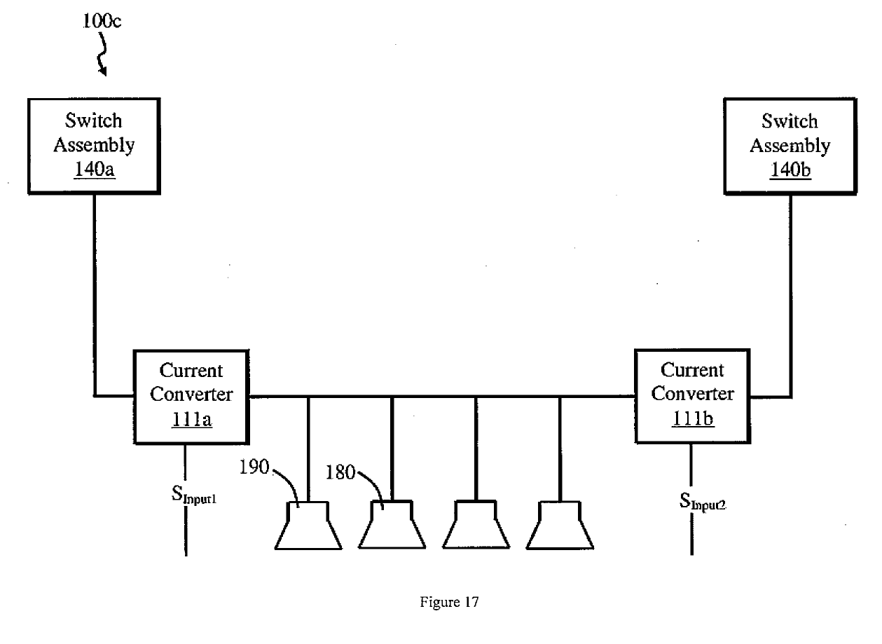

FIG. 17 is a block diagram of a system 100c which controls the operation of an electrical load, and provides power storage. In this embodiment, system 100c includes current converters 111a and 111b operatively coupled to switch assemblies 140a and 140b, respectively. System 100c includes a plurality of lamps operatively coupled to current converters 111a and 111b. The lamps of system 100c can be of many different types, such as solid-state light emitting device 180 and lamp 190, which are discussed in more detail above.

In operation, current converters 111a and 111b receive input signals S_{Input1} and S_{Input2}, respectively. Input signals S_{Input1} and S_{Input2} can be provided in many different ways, such as by the power sources mentioned above. Current converter 111a is repeatably moveable between activated and deactivated conditions in response to activating and deactivating switch assembly 140a. The lamps of system 100c are activated and deactivated in response to activating and deactivating current converter 111a. In this way, the light outputted by the lamps of system 100c is controllable.

Further, current converter 111b is repeatably moveable between activated and deactivated conditions in response to activating and deactivating switch assembly 140b. The lamps of system 100c are activated and deactivated in response to activating and deactivating current converter 111b. In this way, the light outputted by the lamps of system 100c is controllable.

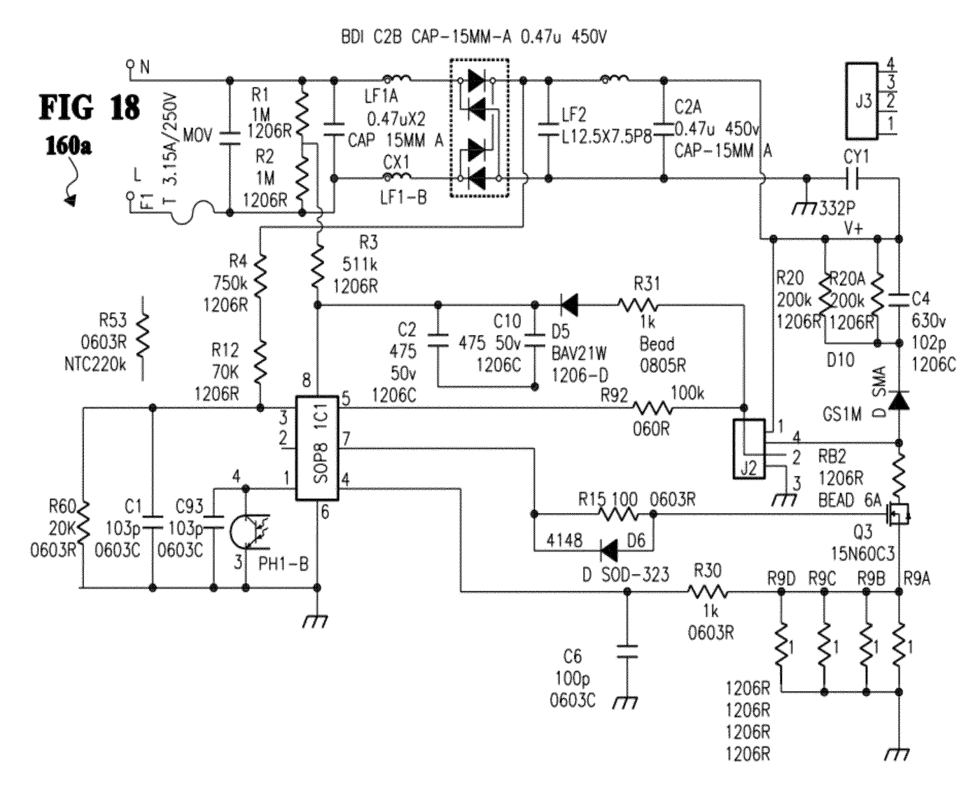

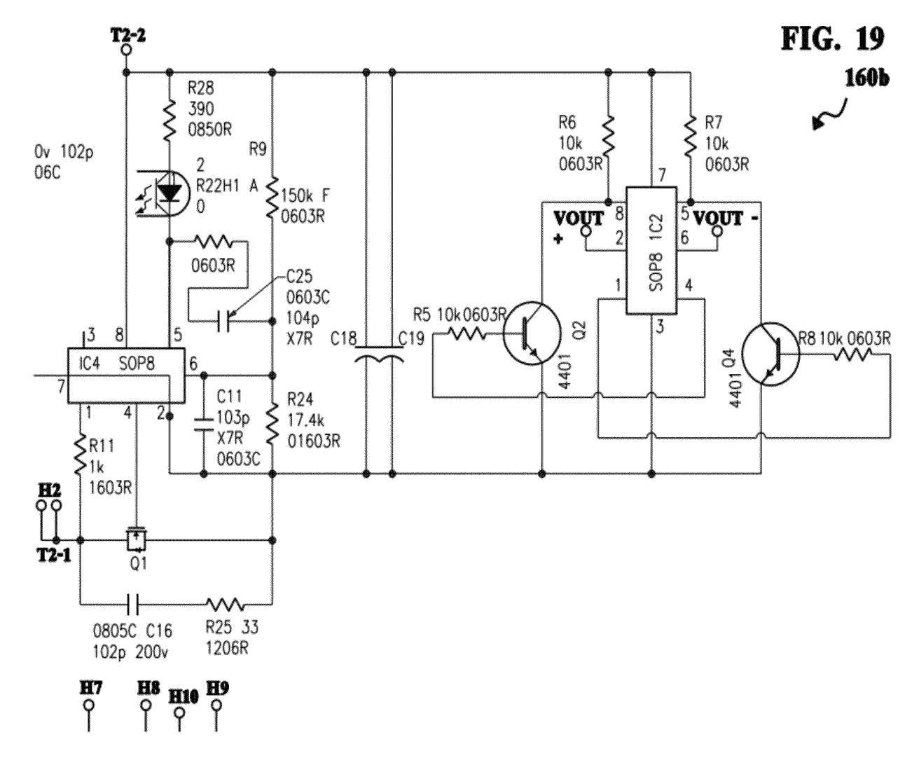

FIG. 18 and FIG. 19 are block diagrams of circuits 160a and 160b which are included in a light switch assembly. The circuits may be external to and/or contained within the enclosure housing the light switch. Part or all of the circuits may be included as part of the switch itself. Circuits 160a and 160b allow the light switch assembly to repeatably move between activated and deactivated conditions, as described in more detail above with FIG. 17. Circuits 160a and 160b allow the light switch assemblies to adjust the power of the signals provided to the lamps of system 100e. The power of the signals provided to the lamps of system 100c can be adjusted in many different ways, such as by adjusting the voltage. More information regarding adjusting the power of a signal is provided in U.S. patent application Ser. No. 12/553,893.

In any of the configurations discussed above, any of the signals Sout, Sout1, Sout2, Scontrol1, Scontrol2, SB1, SB2, etc. may or may not have an additional data portion encoded into the signal. Consequently, any of the signals may provide information and/or power, and information may be provided by the magnitude of voltage as well as by a separate pulsed portion within the main signal.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

What is claimed is:

1. An assembly for selecting and utilizing a power source for electrical energy in a building comprising
a. a first power line providing electrical energy from an alternative energy source
b. a second power line providing electrical energy to and from an electrical energy storage system, wherein the electrical energy storage system comprises a first electrical energy storage medium and a second electrical energy storage medium
c. a third power line providing electrical energy from a power grid
d. an AC to DC converter having (i) a DC side and (ii) an AC side in electrical communication with the third power line
e. a controller in electrical communication with the DC side of the AC to DC converter to supply DC power to at least one of
f. a DC power load associated with the building, wherein the DC power load is other than a load caused by energy storage, and
g. a PWM configured to convert the DC electrical energy to pulsed DC electrical energy having a wave-form other than sinusoidal and frequency other than 50 Hz-60 Hz and wherein the PWM is in electrical communication with a pulsed-DC load associated with the building
h. wherein the controller is additionally configured to switch among the first power line, the second power line, and the third power line based on the cost of electrical power obtained from the power grid.

2. The assembly of claim 1 wherein the controller is configured to receive first information representative of cost of electrical power obtained from the power grid.

3. The assembly of claim 1 further comprising electrical energy storage media comprising one or more batteries.

4. The assembly of claim 3 wherein a number N of said batteries having a voltage V are arranged in series such that the series has a voltage N×V, and wherein the batteries are connected to conductors and switches that enable a first subset of said batteries to provide electricity at a first voltage less than N×V.

5. The assembly of claim 4 wherein the batteries are connected to a second set of conductors and switches configured to charge batteries other than the first subset of said batteries.

6. The assembly of claim 4 wherein a second subset of said batteries provide electricity at second voltage not equal to the first voltage.

7. The assembly of claim 4 wherein the first subset of batteries provide a voltage suitable for DC lighting or pulsed DC lighting.

8. The assembly of claim 6 wherein the second subset of batteries provides a voltage sufficient to run a DC motor.

9. The assembly of claim 8 wherein said voltage provided by the second subset of batteries is between about 12V and 800V.

10. The assembly of claim 7 wherein the first subset of batteries is positioned in proximity to DC lighting.

11. The assembly of claim 10 wherein the first subset of batteries is positioned on or in a lamp or lamp fixture into which the lamp is inserted.

12. The assembly of claim 11 wherein the first subset of batteries is in electrical communication with the DC lighting.

13. The assembly of claim 1 wherein the controller is configured to pulse the pulse width modulator to provide an additional data signal superimposed on the pulsed DC power signal.

14. The assembly of claim 1 wherein the pulsed DC signal is periodic.

15. The assembly of claim 1 wherein the pulsed DC signal is not periodic.

16. The assembly of claim 1 wherein the controller is configured to utilize electricity from solar power and having a voltage between about 12V and 800V.

17. The assembly of claim 1 wherein the controller is configured to provide DC power to LED lighting.

18. The assembly of claim 17 wherein the DC power is pulsed DC power and the LED lighting has LEDs with opposite polarity in a lighting circuit.

19. The assembly of claim 1 wherein the controller is configured to provide DC power to an electric motor.

20. The assembly of claim 19 wherein the DC power is DC power pulsed above and below thresholds and sufficient for driving the electric motor.

21. The assembly of claim 1 wherein the controller is connected to grid power supply and in standby uses grid power only to assess its availability for use for the AC and/or DC load.

22. The assembly of claim 1 wherein the controller is connected to grid power supply and in standby uses grid power only to power a pulse width modulator when the energy storage source and the alternative energy source are not powering DC loads.

23. The assembly of claim 1 wherein the controller is connected to grid power supply and in peak charge times for grid power uses the grid power only to power a pulse width modulator when the batteries and optional alternative energy source are sufficient to power DC loads.

24. The assembly of claim 1 and further comprising at least one selected from a dimmer, multiple switches controlling a single light circuit, 3-way and 4-way switch wiring, a motion sensor, a timer, a camera, a photocell, and a biometric device, each of which encodes a data signal on the DC power signal or the pulsed DC power signal.

25. The assembly of claim 1 and further comprising existing building wiring for the DC or pulsed DC load that is unchanged except for insertion of at least one selected from the pulse width modulator and the controller at an existent electrical box.

26. The assembly of claim 25 wherein a former AC return line in an enclosure not grounded to earth is configured to carry a low DC voltage or a high DC voltage and an earth wire is configured to be DC ground.

27. The assembly of claim 1 wherein the controller obtains information on load and in response
a. switches more or fewer batteries into use in series or in parallel depending on required voltage and required amperage;
b. switches an alternative energy source into or out of use;
c. switches the power grid into or out of use; and/or
d. decreases the electrical load by changing pulse width modulation.

28. The assembly of claim 1 having plural individually controllable lamps on the same circuit, wherein each individually controllable lamp has a controller configured to read a digital data signal encoded on the power signal and each individually controllable lamp is configured to turn on in response to a digital data signal unique to that lamp.
